(19) United States
(12) Patent Application Publication
(10) Pub. No.: US 2007/0094343 A1
(43) Pub. Date: Apr. 26, 2007

(54) System and method of implementing selective session replication utilizing request-based service level agreements

(75) Inventors: Amit D. Sangle, Morgantown, WV (US); John J. Stecher, Rochester, MN (US)

Correspondence Address: IBM CORPORATION, 3605 HIGHWAY 52 NORTH, DEPT 917, ROCHESTER, MN, 55901-7829, US

(73) Assignee: International Business Machines Corporation, Armonk, NY (US)

(21) Appl. No.: 11/259,231

(22) Filed: Oct. 26, 2005

(51) Int. Cl. G06F 15/16

(52) U.S. Cl. 709/207; 709/223

(57) ABSTRACT

A system and method of implementing selective session replication utilizing request-based service level agreements. The present invention includes, but is not limited to, a method, system, and computer-usable medium for assigning a collection of priority ratings to a collection of tasks; comparing a current level of system resource usage utilized by a data processing system executing the collection of tasks with a predetermined threshold; and in response to comparing the current level of system resource usage, enabling session replication of at least one task among the collection of tasks according to the assigned collection of priority ratings and the current level of system resource usage.

### BACKGROUND OF THE INVENTION

1. Technical Field

The present invention relates in general to the field of data processing systems. More specifically, the present invention relates to the field of networked data processing systems. Still more specifically, the present invention relates to a system and method of implementing selective session replication among networked data processing systems

2. Description of the Related Art

A traditional, non-clustered server does not provide any failover or load balancing capabilities. When a traditional server fails, due to natural causes or a system outage, the services provided by the traditional server are unavailable until the server is revived. User sessions logged into the traditional server are lost and all users must log in again and reenter all of the data lost as a result of the server crash.

Today, server clusters provide both scalability and failover capabilities. A server cluster is a group of multiple server instances running simultaneously and working together to provide high availability, reliability, and scalability. From the client point of view, the server cluster appears and operates like a single server instance, but provides uninterrupted service and session data persistence by providing failover and session replication.

A server cluster typically handles two types of sessions: sticky sessions and replicated sessions. Sticky sessions remain on the server among the cluster of servers that received the web request. Other servers in the cluster do not have any knowledge of the session state on the first server. If the first server becomes unavailable, the user utilizing that session must log in again to the web site and re-enter any data stored in the session that was lost during the interruption of service.

A replicated session is a session that is copied to all of the other servers within the server cluster. When the replicated session is modified, any modified data is copied to all of the other servers. If an individual server within the cluster becomes unavailable, the replicated session still exists in the memories of the other servers in the cluster.

Session replication is a resource-intensive operation that is greatly dependent on the amount of information and complexity of the applications utilized in each session. Therefore, there is a need for a system and method of managing a server cluster in a manner that offers scalability and reliability in a resource-efficient manner.

### SUMMARY OF THE INVENTION

The present invention includes, but is not limited to, a method, system, and computer-usable medium for assigning a collection of priority ratings to a collection of tasks; comparing a current level of system resource usage utilized by a data processing system executing the collection of tasks with a predetermined threshold; and in response to comparing the current level of system resource usage, enabling session replication of at least one task among the collection of tasks according to the assigned collection of priority ratings and the current level of system resource usage.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purpose and advantages thereof, will best be understood by reference to the following detailed description of an illustrative embodiment when read in conjunction with the accompanying drawings, wherein:

FIG. 1 is a block diagram of an exemplary network in which a preferred embodiment of the present invention may be implemented;

FIG. 2 is a block diagram of an exemplary data processing system in which a preferred embodiment of the present invention may be implemented;

FIG. 3 is a block diagram of exemplary contents of a system memory of a server in which a preferred embodiment of the present invention may be implemented; and

FIG. 4 is a high-level logical flowchart illustrating an exemplary method of selective session replication according to a preferred embodiment of the present invention.

### DETAILED DESCRIPTION OF A PREFERRED EMBODIMENT

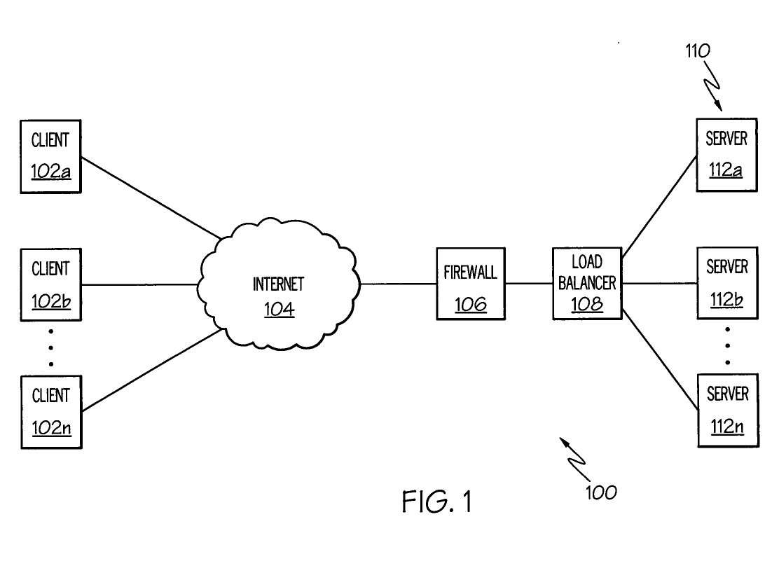

Referring now to the figures, and in particular, referring to FIG. 1, there is illustrated a block diagram depicting an exemplary network 100 which a preferred embodiment of the present invention may be implemented. As illustrated, network 100 includes multiple clients 102a-n, Internet 104, firewall 106, load balancer 108, and server cluster 110.

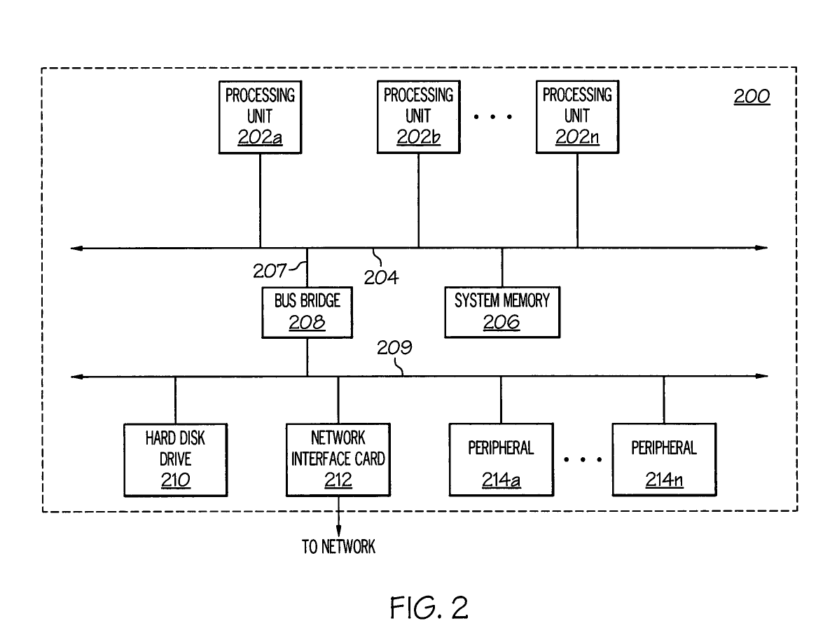

In a preferred embodiment of the present invention, server cluster 110 provides a service (e.g., hosts a website) that may be accessed by clients 102a-n via Internet 104. Server cluster 110 is implemented as a collection of servers 112a-n, discussed in more detail herein in conjunction with FIG. 2. As well known to those with skill in the art, servers 112a-n work together within the cluster to provide high availability, reliability, and scalability by appearing to clients 102a-n as a single server instance. If one of servers 112a-n (e.g., server 112a) becomes unavailable, the work previously assigned to server 112a is distributed among the remaining servers in cluster 110.

Firewall 106, which may be implemented either as hardware, software, or a combination of both hardware and software, is utilized to prevent unauthorized Internet 104 users from accessing server cluster 110. All messages entering or leaving server cluster 110 pass through firewall 106, which examines each message and blocks those that do not meet the specified security criteria. Load balancer 108 intercepts each message that has been allowed to pass through firewall 106 and distributes the messages in a manner that attempts to balance the workload across server cluster 110.

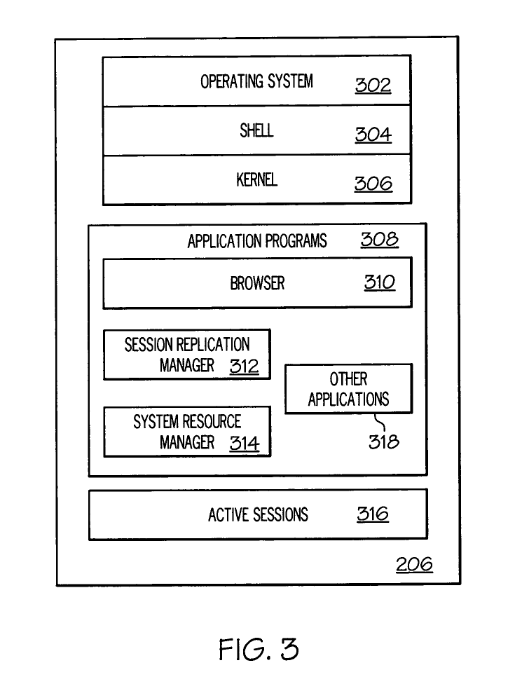

FIG. 2 is block diagram illustrating a data processing system 200 utilized to implement clients 102a-n and server 112a-n. As illustrated, data processing system 200 includes processing units 202a-n coupled by system interconnect 204. Also coupled to processing units 202a-n is system memory 206, discussed herein in more detail in conjunction with FIG. 3. Bus bridge 208 and mezzanine interconnect 207 couples system interconnect 204 to peripheral interconnect 209. Those with skill in the art will appreciate that peripheral interconnect 209 may be implemented as a peripheral computer interconnect (PCI), accelerated graphics port (AGP), or any other peripheral bus. Coupled to peripheral interconnect 209 is hard disk drive 210, utilized by data processing system 200 as a mass storage device, and network interface card 212 which serves as a connection to a network, and other peripherals 214a-n.

Those skilled in the art will appreciate that data processing system 200 can include many additional components not specifically illustrated in FIG. 2. Because such additional components are not necessary for an understanding of the present invention, they are not illustrated in FIG. 2 or discussed further herein. It should be understood, however, that the enhancements to data processing system 200 to improve session replication provided by the present invention are applicable to data processing systems of any system architecture and are in no way limited to the generalized multi-processor architecture or symmetric multi-processing (SMP) architecture illustrated in FIG. 2.

FIG. 3 is a block diagram depicting exemplary contents of system memory 206 according to a preferred embodiment of the present invention. Operating system 302 includes a shell 304 for providing transparent user access to resources such as application programs 308. Generally, shell 304 is a program that provides an interpreter and an interface between the user and operating system. More specifically, shell 304 executes commands that are entered into a command line user interface or from a file. Thus, shell 304 (as it is called in the UNIX® operating system), also called a command processor in the Windows® operating system, is generally the highest level of the operating system software hierarchy and serves and a command interpreter. The shell provides a system prompt, interprets commands entered by keyboard, mouse, or other user input media, and sends the interpreted command(s) to the appropriate lower levels of the operating system (e.g., a kernel 306) for processing. Note that while shell 304, as illustrated, is a text-based, line-oriented user interface, the present invention will equally well support other user interface modes, such as graphical, voice, gestural, etc.

As depicted, operating system 302 also includes kernel 306, which includes lower levels of functionality for operating system 302, including providing essential services required by other parts of operating system 302 and application programs 308, including memory management, process and task management, disk management, and mouse and keyboard management.

Application programs 308 typically include a browser 310. Browser 310 includes program modules and instructions enabling World Wide Web (WWW) client (e.g., clients 102a-n) to send and receive network messages to Internet 104 utilizing HyperText Transfer Protocol (HTTP) messaging.

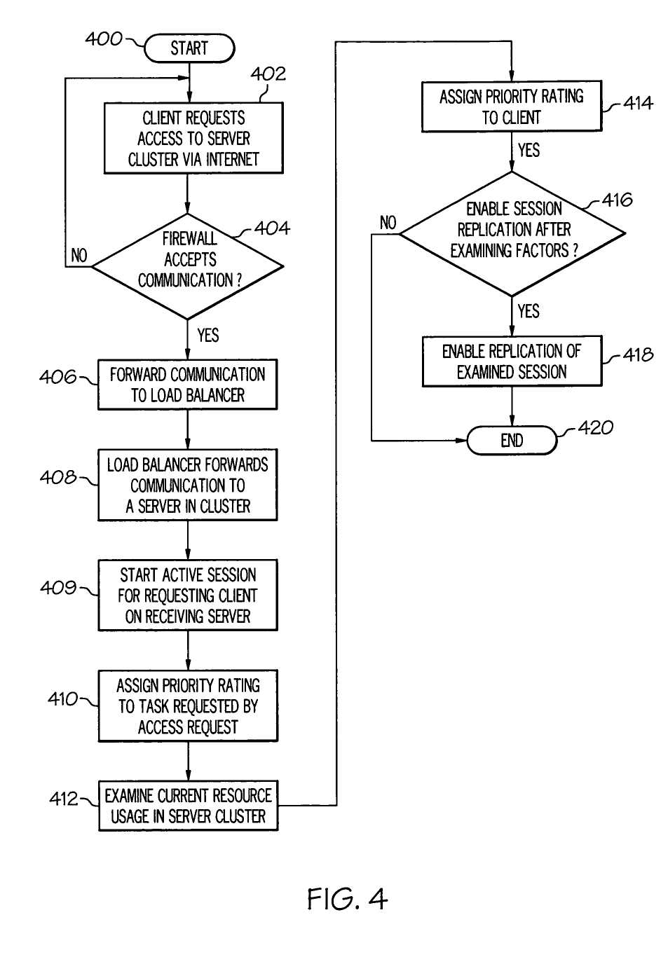

Application programs 308 in system memory 206 may also include session replication manager 312, discussed herein in more detail in conjunction with FIG. 4, system resource manager 314, and other applications 318 (e.g., word processors, spreadsheets, databases, etc.). System memory 206 also includes active sessions 316, which are enabled when clients 102a-n log on to server cluster 110 to utilize the service provided by server cluster 110. The handling and replication of active sessions 316 will be discussed herein in more detail in conjunction with FIG. 4.

FIG. 4 is a high-level logical flowchart diagram illustrating an exemplary method of implementing selective session replication utilizing request-based service level agreements according to a preferred embodiment of the present invention. For example, assume that server cluster 110 provides an airline reservation system utilized by travel agents and/or passengers (clients 102a-n). When clients 102a-n request access to the airline reservation system (step 402), their requests fall within three cases: (1) flight price quote, (2) flight availability, or (3) flight booking. Each of the cases has an assigned priority rating. For example, a flight price quote may be considered a low priority function, while flight availability has a higher priority rating. A flight booking request has the highest priority rating.

Firewall 106 examines the access request issued from a client 102a and determines whether or not to accept the access request. As previously described, a firewall (e.g., firewall 106) determines whether or not to accept an access request by determining if the access request meets a predetermined set of criteria called “firewall rules”.

If firewall 106 does not accept the access request, the process returns to step 402 and proceeds in an iterative fashion. On the other hand, if firewall 106 accepts the access request, the process proceeds to step 406, which illustrates firewall 106 forwarding the access request to load balancer 108. Load balancer 108 utilizes an algorithm to determine to which server 112a-n to forward the access request to balance the workload across server cluster 110 (step 408).

The process continues to step 409, which illustrates receiving server (e.g., server 112a) starting a session to handle communication from client 102a. This session is stored in system memory 104 with other active sessions 316, as illustrated in FIG. 3. System resource manager 314 assigns a priority rating to the task requested by access requests from client 102a (step 410). For example, utilizing the flight booking above-described flight booking example, system resource manager 314 examines the access request and if the access request is a flight price quote, system resource manager 314 assigns a low priority rating to the request.

After assigning a priority rating to the task requested by an access request, system resource manager 314 examines a current resource usage in server cluster 110 (step 412). Those with skill in the art will appreciate that the current resource usage in server cluster 110 can be measured by type of hardware, software, or combination of hardware and software system resource monitor. Also, any performance metric or a combination of performance metrics may be utilized in the measuring of the current resource usage in server cluster 110. Some performance metrics include, but are not limited to: processing unit, memory, and interconnect usage.

The process proceeds to step 414, which illustrates system resource manager 314 assigning a priority rating to client 102a. Clients 102a-n may have different priority ratings depending on the quality of service requested. For example, utilizing the flight booking example, a regular, independent customer may be considered a low priority client while a high-volume travel agent may be considered a high-priority client. Businesses may want to ensure that higher-priority clients receive more reliable service than lower-priority clients.

The process continues to step 416, which depicts system replication manager 312 determining whether or not the current session with client 102a is a candidate for session replication. In a preferred embodiment of the present invention, system replication manager 312 takes the measured factors (e.g., priority rating of the task, priority rating of the client utilizing the session in question, and the current resource utilization) to determine whether the current session utilized by client 102a is a candidate for replication. An administrator of a flight booking system may specify resource thresholds for the different task priority ratings. For example, if the system resources utilized on server cluster 110 is relatively light (e.g., less than 30% utilized), system replication manager 312 may replicate all active sessions 316, regardless of the individual priority ratings of each task.

If the system resources utilized on server cluster 110 is moderate (e.g., greater than 30%, but less than 60% utilized), system replication manager 312 may not replication low priority rated sessions (e.g., such as those sessions where the clients are merely obtaining flight price quotes), but will replicate all other higher priority rated sessions (e.g., flight availability and flight booking functions).

If the system resources utilized on system cluster 110 is heavy (e.g., greater than 60%), system replication manager 312 may only replicate sessions that are performing high-priority rated tasks (e.g., flight booking functions). System replication manager 312 may also take the priority rating of the client 102a-n utilizing active sessions 316 into account when determining whether or not to replicate certain sessions.

For example, a regular independent customer to a flight booking system may be considered a low-priority client and not a candidate for session replication unless booking tickets, which is considered a high-priority task. A high-volume travel agent may be considered a high-priority client where any of the travel agent's sessions are replicated regardless of the priority rating of the task and the current system resource utilization.

If system replication manager 312 determines that the current session should not be replicated, the process proceeds to step 422, which illustrates the current session assigned to a single server among server cluster 110. The process continues to step 424, which depicts the process ending.

Returning to step 416, if system replication manager 312 determines that the current session should be replicated, the process continues to step 420, which depicts system replication manager 312 replicating the current session and the replicated sessions are assigned to multiple servers, as illustrated in step 422. The process continues to step 422, which illustrates the process ending.

As disclosed, the present invention includes, but is not limited to, a method, system, and computer-usable medium for assigning a collection of priority ratings to a collection of tasks; comparing a current level of system resource usage utilized by a data processing system executing the collection of tasks with a predetermined threshold; and in response to comparing the current level of system resource usage, enabling session replication of at least one task among the collection of tasks according to the assigned collection of priority ratings and the current level of system resource usage.

It should be understood that at least some aspects of the present invention may alternatively be implemented in a computer-usable medium that contains a program product. Program defining functions on the present invention can be delivered to a data storage system or a computer system via a variety of signal-bearing media, which include, without limitation, non-writable storage media (e.g., CD-ROM), writable storage media (e.g., floppy diskette, hard disk drive, read/write CD-ROM, optical media), and communication media, such as computer and telephone networks including Ethernet, the Internet, wireless networks, and like network systems. It should be understood, therefore, in such signal-bearing media when carrying or encoding computer readable instructions that direct method functions in the present invention, represent alternative embodiments of the present invention. Further it is understood that the present invention may be implemented by a system having means in the form of hardware, software, or a combination of software and hardware as described herein or their equivalent.

What is claimed is:

1. A method comprising:
assigning a plurality of task priority ratings to a plurality of tasks;
comparing a current level of system resource usage utilized by a data processing system executing said plurality of tasks with a predetermined threshold; and
in response to said comparing said current level of system resource usage, enabling session replication of at least one task among said plurality of tasks according to said assigned plurality of task priority ratings and said current level of system resource usage.

2. The method according to claim 1, further comprising:
assigning a plurality of client priority ratings to a plurality of clients requesting executing of said plurality of tasks.

3. The method according to claim 2, wherein said enabling session replication further comprises:
in response to said comparing said current level of system resource usage, enabling session replication of at least one task among said plurality of tasks according to said assigned plurality of priority ratings, said current level of system resource usage, and said plurality of client priority ratings.

4. A data processing system comprising:
at least one processing unit;
an interconnect coupled to said at least one processing unit;
a system memory coupled to said interconnect;
a computer-usable medium embodying computer program code, said computer program code comprising instructions executable by said at least one processing unit and configured for:
assigning a plurality of task priority ratings to a plurality of tasks;
comparing a current level of system resource usage utilized by a data processing system executing said plurality of tasks with a predetermined threshold; and
in response to said comparing said current level of system resource usage, enabling session replication of at least one task among said plurality of tasks according to said assigned plurality of task priority ratings and said current level of system resource usage.

5. The data processing system according to claim 4, wherein said instructions are further configured for:
assigning a plurality of client priority ratings to a plurality of clients requesting executing of said plurality of tasks.

6. The data processing system according to claim 5, wherein said instructions are further configured for:
in response to said comparing said current level of system resource usage, enabling session replication of at least one task among said plurality of tasks according to said assigned plurality of priority ratings, said current level of system resource usage, and said plurality of client priority ratings.

7. A computer-usable medium embodying computer program code, said computer program code comprising computer executable instructions configured for:
assigning a plurality of task priority ratings to a plurality of tasks;
comparing a current level of system resource usage utilized by a data processing system executing said plurality of tasks with a predetermined threshold; and
in response to said comparing said current level of system resource usage, enabling session replication of at least one task among said plurality of tasks according to said assigned plurality of task priority ratings and said current level of system resource usage.

8. The computer-usable medium according to claim 7, wherein said embodied computer program code further comprises computer executable instructions configured for:
assigning a plurality of client priority ratings to a plurality of clients requesting executing of said plurality of tasks.

9. The computer-usable medium according to claim 8, wherein said embodied computer program code further comprises computer executable instructions configured for:
in response to said comparing said current level of system resource usage, enabling session replication of at least one task among said plurality of tasks according to said assigned plurality of priority ratings, said current level of system resource usage, and said plurality of client priority ratings.
